(19) United States
(12) Patent Application Publication
(10) Pub. No.: US 2024/0031493 A1
(43) Pub. Date: Jan. 25, 2024

(54) SYSTEM AND METHOD FOR HIERARCHICAL ACCOUNT BALANCE MANAGEMENT

(71) Applicant: Verizon Patent and Licensing Inc., Basking Ridge, NJ (US)

(72) Inventors: Madhan Muralimanohar, Tampa, FL (US); Harinder S. Lakhian, Plano, TX (US); Hans Raj Nahata, New Providence, NJ (US)

(21) Appl. No.: 17/814,000

(22) Filed: Jul. 21, 2022

(51) Int. Cl. H04M 15/00

(52) U.S. Cl. CPC H04M 15/88; H04M 15/41; H04M 15/46

(57) ABSTRACT

Systems and methods described herein provide a hierarchical Account Balance Management Function (ABMF) architecture for a Converged Charging System. Multiple distributed account management devices and a centralized account management device are provided. The centralized account management device includes one or more processors to allocate, to the multiple distributed account management devices, a pre-authorized consumption limit for a shared consumption plan; receive, from one of the multiple distributed account management devices, a request for an additional consumption limit from the shared consumption plan; allocate, to the one of the multiple distributed account management devices, the additional consumption limit; and update an account balance for the shared consumption plan based on allocating the additional consumption limit.

### BACKGROUND

Currently, there are a number of types of mechanisms for charging or billing wireless users for data usage. An offline charging mechanism does not provide for real-time monitoring of data usage and users may be billed after services are rendered. After the user has completed using the service, information associated with the usage (e.g., data consumed while using the service, time spent using the service, etc.) may be collected and processed and sent to a billing domain for reconciliation and billing the user.

An online charging mechanism monitors data usage in real time and provides services based on the monitoring. If a user is utilizing a service that is charged online, the service will be monitored for data usage while the service is being rendered. For example, if the user's data usage while using the service rises above a particular threshold (e.g., a monthly data allotment threshold, a daily data allotment threshold, etc.), the user's data usage may be modified. A converged charging mechanism combines aspects of the offline mechanism and the online mechanism.

### BRIEF DESCRIPTION OF THE DRAWINGS

FIG. 1 is a diagram illustrating a network environment according to an implementation described herein;

FIG. 2 is a diagram illustrating connections among devices in a portion of the network environment of FIG. 1;

FIG. 3 is a diagram of example components that may be included in one or more of the devices described herein;

FIG. 4 is a block diagram of example components of a system that may correspond to a portion of the network environment of FIG. 1 or FIG. 2;

FIG. 5 is a signal flow diagram illustrating example communications for establishing consumption limits in a hierarchical Account Balance Management Function (ABMF) architecture, according to an implementation described herein;

FIGS. 6A and 6B are signal flow diagrams illustrating example communications for tracking consumption in a hierarchical ABMF architecture, according to an implementation described herein; and

FIG. 7 is a flow diagram illustrating an example process for implementing a hierarchical ABMF architecture, according to an implementation described herein.

### DETAILED DESCRIPTION OF THE EXAMPLE EMBODIMENTS

The following detailed description refers to the accompanying drawings. The same reference numbers in different drawings may identify the same or similar elements. Also, the following detailed description does not limit the invention.

Converged charging is a process in which online and offline charging are combined. With a converged charging system (CCS) in a Fifth Generation (5G) network, a single system and a single interface may be able to support both the offline charging mechanism and the online charging mechanism. The CCS may include an Account Balance Management Function (ABMF) with defined functionality to accurately count and maintain a consumption counter for a given user.

Network providers may offer shared consumption plans to customers. As an example, an account with multiple devices (e.g., user equipment) may share a monthly data limit (e.g., a 50 gigabyte (GB) consumption limit for 5 lines on the same account). The shared consumption plan may use a common network currency consumption counter for use with all the devices on an account. In the case of a shared consumption plan, all the devices need to be provisioned in the charging platform (e.g., CCS) to share the common network currency consumption counter.

Currently, the CCS offers options for a fully centralized ABMF or a fully decentralized ABMF. In a fully centralized ABMF, all charging functions (CHF) of the CCS use a centralized instance of the ABMF. Each CHF will receive network counters from the centralized ABMF for every credit control request (CCR) in the 5G network. Thus, a fully centralized ABMF can increase the number of transactions to the ABMF and result in latency/delay during a call flow. In a fully decentralized ABMF, devices in an account can be provisioned in distributed ABMF instances based on geographical location to avoid latency during call flow. However, with decentralized ABMFs, each ABMF instance has to perform periodic sync-ups with all the other ABMF instances to maintain an up-to-date consumption counter, thus, increasing the number of network transactions exponentially over a centralized ABMF.

Systems and methods described herein provide a hierarchical ABMF that includes a primary ABMF (e.g., centralized) to maintain an aggregated common consumption counter and secondary ABMFs (e.g., distributed) to manage granted account level counters. The primary ABMF (P-ABMF) may allocate network consumption counters to a secondary ABMF (S-ABMF) per account. The S-ABMF can request additional counters when approaching or exhausting the granted account level counters. Subscribers may be provisioned in distributed instances of the CCS across a provider's network (e.g., national, regional, etc.) based on geographical location. All S-ABMFs within CCS instances may interface with an Account Grouper in the P-ABMF to obtain the network counters and also report consumptions of each subscriber. According to an implementation, the S-ABMF and P-ABMF may communicate using a standards-based interface (e.g., an Rc interface). All subscribers may be provisioned in single instance of the Account Grouper to maintain the shared network currency consumption counter.

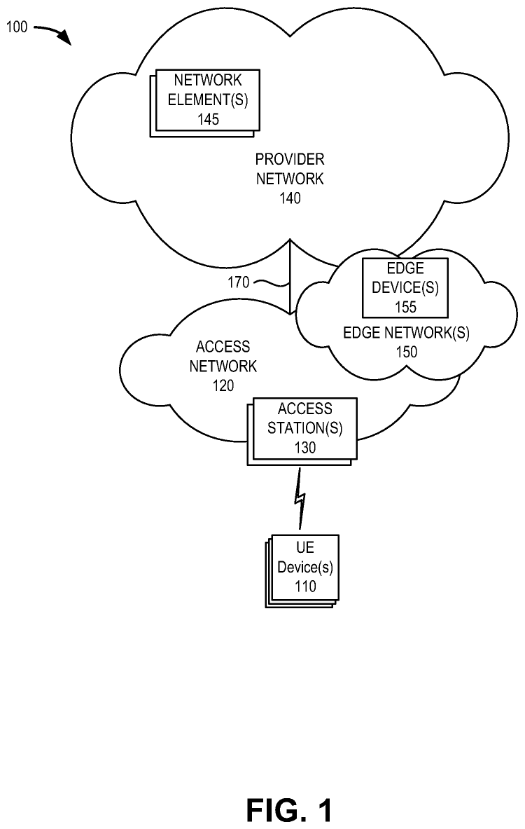

FIG. 1 is a diagram illustrating concepts described herein. As shown in FIG. 1, an environment 100 may include one or more user equipment (UE) devices 110 (referred to herein collectively as UEs 110 or individually as UE 110), an access network 120, one or more wireless access stations 130 (also referred to as “access stations 130”), a provider network 140, and one or more edge networks 150.

UE 110 may include a handheld wireless communication device; a wireless Machine-Type-Communication (MTC) device that communicates wirelessly with other devices over a machine-to-machine (M2M) interface; an Internet of Things (IoT) device; a wearable computer device (e.g., a head-mounted display computer device, a head-mounted camera device, a wristwatch computer device, etc.); a smartphone; a global positioning system (GPS) device; a media playing device; a portable gaming system; a laptop, tablet, or another type of portable computer; and/or any other type of computer device with wireless communication capabilities. UE 110 may be used for voice communication, mobile broadband services (e.g., video streaming, real-time gaming, premium Internet access etc.), best-effort data traffic, and/or other types of applications.

According to implementations described herein, UE 110 may be configured to use one or more applications or services that use offline or online charging services. For example, UE 110 may access an offline application or service that provides data regarding user usage to a billing domain after the user has stopped using the application or service. As another example, UE 110 may access an online application or service that provides real-time information regarding user usage.

Access network 120 may provide access to provider network 140 and/or edge network 150 for wireless devices, such as UE 110. Access network 120 may enable UE 110 to connect to provider network 140 or edge network for Internet access, non-Internet Protocol (IP) data delivery, cloud computing, mobile telephone service, Short Message Service (SMS) message service, Multimedia Message Service (MMS) message service, and/or other types of data services. Access network 120 may include wireless access stations 130, and UE 110 may wirelessly communicate with access network 120 via wireless access station 130. Access network 120 may establish a packet data network connection between UE 110 and provider network 140 via one or more Access Point Names (APNs). For example, wireless access network 120 may establish an Internet Protocol (IP) connection between UE 110 and provider network 140. In another implementation, access network 120 may provide access to a service or application layer network, a cloud network, a multi-access edge computing (MEC) network, a fog network, and so forth. Furthermore, access network 120 may enable a server device to exchange data with UE device 110 using a non-IP data delivery method such as Data over Non-Access Stratum (DoNAS).

Access network 120 may include a 5G access network or another advanced network, such as a Fourth Generation (4G) LTE network. Additionally access network 120 may include functionality such as a mm-wave Radio Access Network (RAN); advanced or massive multiple-input and multiple-output (MIMO) configurations (e.g., an 8×8 antenna configuration, a 16×16 antenna configuration, a 256×256 antenna configuration, etc.); cooperative MIMO (CO-MIMO); carrier aggregation; relay stations; Heterogeneous Networks (HetNets) of overlapping small cells and macrocells; Self-Organizing Network (SON) functionality; MTC functionality, such as 1.4 MHz wide enhanced MTC (eMTC) channels (also referred to as category Cat-M1), Low Power Wide Area (LPWA) technology such as Narrow Band (NB) IoT (NB-IoT) technology, and/or other types of MTC technology; and/or other types of 5G functionality.

Wireless access station 130 may include a gNodeB base station device and/or an eNodeB base station device that includes one or more devices (e.g., wireless transceivers) and other components and functionality that allow UE 110 to wirelessly connect to access network 120. Wireless access station 130 may correspond to a macrocell or to a small cell (e.g., a femtocell, a picocell, a microcell, etc.). In other implementations, wireless access station 130 may include another type of base station for another type of wireless network. Wireless access stations 130 may connect to provider network 140 via backhaul links 170.

Provider network 140 may include a local area network (LAN), a wide area network (WAN), a metropolitan area network (MAN), an optical network, a cable television network, a satellite network, a wireless network (e.g., a code-division multiple access (CDMA) network, a general packet radio service (GPRS) network, and/or a long-term evolution (LTE) network), an ad hoc network, a telephone network (e.g., the Public Switched Telephone Network (PSTN) or a cellular network), an intranet, or a combination of networks. In one implementation, provider network 140 may allow the delivery of Internet Protocol (IP) services to UE 110, and may interface with other external networks, such as private IP networks.

According to one implementation, provider network 140 may include a core network for one or multiple access networks 120. For example, provider network 140 may include the core part of a 5G New Radio network, etc. Depending on the implementation, provider network 140 may include various network elements 145, such as a gateway, a support node, a serving node, a router, a switch, a bridge, as well as other network elements pertaining to various network-related functions, such as billing, security, authentication and authorization, network polices, subscriber profiles, etc. In some implementations, provider network 140 may include an Internet Protocol Multimedia Sub-system (IMS) network (not shown in FIG. 1). An IMS network may include a network for delivering IP multimedia services and may provide media flows between UE 110 and external IP networks (not shown in FIG. 1).

Each edge network 150 may be associated with one or more wireless access stations 130 and may provide edge services for UE devices 110 attached to the wireless access station 130. At least a portion of edge network 150 (e.g., a MEC platform) may be in proximity to the wireless access station 130 from a geographic and network topology perspective, thus enabling low latency communication with UE device 110 and/or wireless access station 130. As an example, edge network 150 may be located on a same site as one of the wireless access station 130. As another example, edge network 150 may be geographically closer to the wireless access station 130 and reachable via fewer network hops and/or fewer switches than other wireless access station 130 and/or data networks. Edge network 150 may include edge devices 155 that may be configured to provide various services and/or functions. Edge devices 155 may provide MEC services to UE device 110, such as, for example, services from an edge application server.

Although FIG. 1 shows exemplary components of environment 100, in other implementations, environment 100 may include fewer components, different components, differently arranged components, or additional functional components than depicted in FIG. 1. Additionally, or alternatively, one or more components of environment 100 may perform functions described as being performed by one or more other components of environment 100.

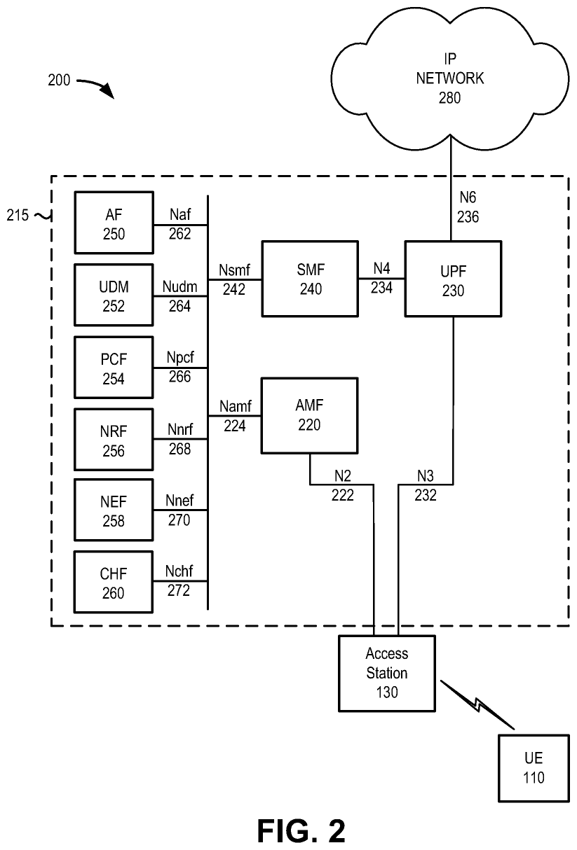

FIG. 2 is a diagram illustrating a network environment 200 that includes exemplary components of environment 100 according to an implementation described herein. As shown in FIG. 2, network environment 200 may include UE device 110, wireless access station 130, a core network 215, and an IP network 280. Core network 215 and IP network 280 may correspond to, or be included in, provider network 140. In other implementations, one or more functions shown in core network 215 may be included in edge network 150.

Core network 215 may include an Access and Mobility Management Function (AMF) 220, a User Plane Function (UPF) 230, a Session Management Function (SMF) 240, an Application Function (AF) 250, a Unified Data Management (UDM) 252, a Policy Control Function (PCF) 254, a Network Repository Function (NRF) 256, a Network Exposure Function (NEF) 258, and a Charging Function (CHF) 260. AMF 220, UPF 230, SMF 240, AF 250, UDM 252, PCF 254, NRF 256, NEF 258, and CHF 260 may correspond to network elements 145 of FIG. 1 and may each be implemented as separate network devices or as nodes shared among one or more network devices. While FIG. 2 depicts a single AMF 220, UPF 230, SMF 240, AF 250, UDM 252, PCF 254, NRF 256, NEF 258, and CHF 260 for illustration purposes, in practice, FIG. 2 may include multiple wireless access stations 130, AMFs 220, UPFs 230, SMFs 240, AFs 250, UDMs 252, PCFs 254, NRFs 256, NEFs 258, and/or CHFs 260.

Wireless access station 130 may include one or more devices and other components and functionality that enable UE 110 to wirelessly connect to access network 120 using 5G Radio Access Technology (RAT). Wireless access station 130 may communicate with AMF 220 using an N2 interface 222 and communicate with UPF using an N3 interface 232.

AMF 220 may perform registration management, connection management, reachability management, mobility management, lawful intercepts, Short Message Service (SMS) transport between UE 110 and an SMS function (not shown in FIG. 2), session management messages transport between UE 110 and SMF 240, access authentication and authorization, location services management, functionality to support non-3GPP access networks, and/or other types of management processes. AMF 220 may be accessible by other function nodes via a Namf interface 224.

UPF 230 may maintain an anchor point for intra/inter-RAT mobility, maintain an external Packet Data Unit (PDU) point of interconnect to a data network (e.g., IP network 280, etc.), perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, send and forward an “end marker” to a Radio Access Network (RAN) node (e.g., wireless access station 130), and/or perform other types of user plane processes. UPF 230 may communicate with SMF 240 using an N4 interface 234 and connect to IP network 280 using an N6 interface 236.

SMF 240 may perform session establishment, modification, and/or release, perform IP address allocation and management, perform Dynamic Host Configuration Protocol (DHCP) functions, perform selection and control of UPF 230, configure traffic steering at UPF 230 to guide traffic to the correct destination, terminate interfaces toward PCF 254, perform lawful intercepts, charge data collection, support charging interfaces, control and coordinate charging data collection, termination of session management parts of Non-Access Stratum (NAS) messages, perform downlink data notification, manage roaming functionality, and/or perform other types of control plane processes for managing user plane data. SMF 240 may report data usage information to CHF 260 when the UE 110 is accessing applications or services that use online or offline charging. More particularly, according to implementations described herein, SMF 240 may be included in an edge network data center and provide session charging information to a regional CHF 260 associated with that edge network data center. SMF 240 may be accessible via an Nsmf interface 242.

AF 250 may provide services associated with a particular application, such as, for example, application influence on traffic routing, accessing NEF 258, interacting with a policy framework for policy control, and/or other types of applications. AF 250 may be accessible via an Naf interface 262.

UDM 252 may maintain subscription information for UEs 110, manage subscriptions, generate authentication credentials, handle user identification, perform access authorization based on subscription data, perform network function registration management, maintain service and/or session continuity by maintaining assignment of SMF 240 for ongoing sessions, support SMS delivery, support lawful intercept functionality, and/or perform other processes associated with managing user data. UDM 252 may be accessible via a Nudm interface 264.

PCF 254 may support policies to control network behavior, provide policy rules to control plane functions (e.g., to SMF 240), access subscription information relevant to policy decisions, perform policy decisions, and/or perform other types of processes associated with policy enforcement. PCF 254 may be accessible via Npcf interface 266. According to an implementation, PCF 254 may be associated with an edge network data center that obtains a pre-authorized consumption counter limit from a secondary ABMF.

NRF 256 may support a service discovery function and maintain a profile of available network function (NF) instances and their supported services. An NF profile may include an NF instance identifier (ID), an NF type, a Public Land Mobile Network identifier (PLMN-ID) associated with the NF, a network slice ID associated with the NF, capacity information for the NF, service authorization information for the NF, supported services associated with the NF, endpoint information for each supported service associated with the NF, and/or other types of NF information. NRF 256 may be accessible via an Nnrf interface 268.

NEF 258 may expose capabilities and events to other NFs, including third-party NFs, AFs, edge computing NFs, and/or other types of NFs. Furthermore, NEF 258 may secure provisioning of information from external applications to access network 120, translate information between access network 120 and devices/networks external to access network 120, support a Packet Flow Description (PFD) function, and/or perform other types of network exposure functions. NEF 258 may be accessible via Nnef interface 270.

CHF 260 may provide an interface to a CCS. CHF 260 may include the interface between the CCS and the provider network 140. CHF 260 may provide spending limits and quotas (such as consumption counter limits identified by an ABMF) for services to SMF 240 and may collect usage information from SMF 240 for online and offline services. For example, CHF 260 may generate a charging record for UE 110 based on data flow information associated with UE 110. CHF 260 may be accessible via Nchf interface 272.

In some implementations, one or more network functions of core network 215 may be deployed locally (e.g., in edge network 150). For example, according to implementations described herein, local instances of SMF 240, PCF 254, and/or CHF 260 may be deployed in an edge network 150 location.

IP network 280 may include a data network, such as a packet data network. A particular IP network 280 may be associated with an Access Point Name (APN), and UE device 110 may request a connection to the particular IP network 280 using the APN. IP network 280 may include, and/or be connected to and enable communication with, a local area network (LAN), a wide area network (WAN), a metropolitan area network (MAN), an autonomous system (AS) on the Internet, an optical network, a cable television network, a satellite network, a wireless network (e.g., a 5G system and/or an LTE network), an ad hoc network, a telephone network (e.g., the Public Switched Telephone Network (PSTN) or a cellular network), an intranet, or a combination of networks.

Although FIG. 2 shows exemplary components of core network 215, in other implementations, core network 215 may include fewer components, different components, differently arranged components, or additional components than depicted in FIG. 2. Additionally, or alternatively, one or more components of core network 215 may perform functions described as being performed by one or more other components of core network 215. For example, core network 215 may include additional function nodes not shown in FIG. 2, such as an Authentication Server Function (AUSF), a Non-3GPP Interworking Function (N3IWF), a Unified Data Repository (UDR), an Unstructured Data Storage Network Function (UDSF), a 5G Equipment Identity Register (5G-EIR) function, a Location Management Function (LMF), a Security Edge Protection Proxy (SEPP) function, a Network Slice Selection Function (NSSF) and/or other types of functions. Furthermore, while particular interfaces have been described with respect to particular function nodes in FIG. 2, additionally or alternatively, core network 215 may include a reference point architecture that includes point-to-point interfaces between particular function nodes.

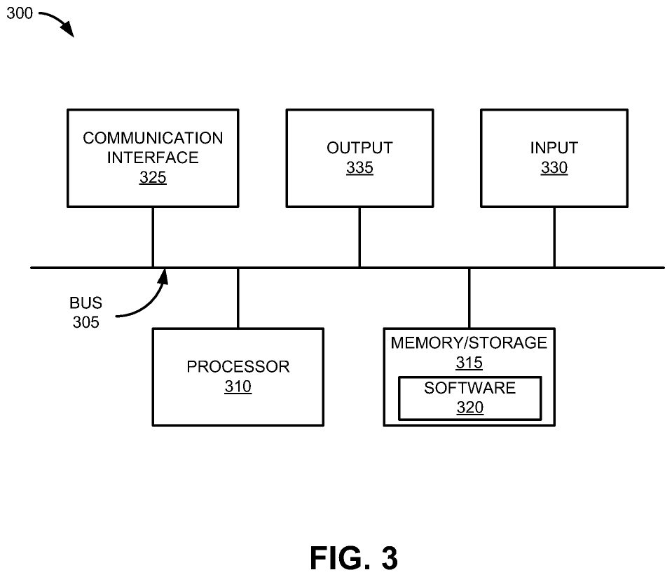

FIG. 3 is a diagram illustrating exemplary components of a device 300 that may correspond to one or more of the devices described herein. For example, device 300 may correspond to components included in UE 110, wireless access station 130, network elements 145, AMF 220, UPF 230, SMF 240, AF 250, UDM 252, PCF 254, NRF 256, NEF 258, CHF 260, and/or other components of access network 120 and/or provider network 140. As illustrated in FIG. 3, according to an exemplary embodiment, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, and/or clocks.

Processor 310 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc. Processor 310 may be a dedicated component or a non-dedicated component (e.g., a shared resource).

Processor 310 may control the overall operation or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, etc.

Memory/storage 315 includes one or multiple memories and/or one or multiple other types of storage mediums. For example, memory/storage 315 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory (e.g., a NAND flash, a NOR flash, etc.), and/or some other type of memory. Memory/storage 315 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 315 may include a drive for reading from and writing to the storage medium.

Memory/storage 315 may be external to and/or removable from device 300, such as, for example, a Universal Serial Bus (USB) memory stick, a dongle, a hard disk, mass storage, off-line storage, network attached storage, or some other type of storing medium. Memory/storage 315 may store data, software, and/or instructions related to the operation of device 300.

Software 320 includes an application or a program that provides a function and/or a process. Software 320 may include an operating system. Software 320 is also intended to include firmware, middleware, microcode, hardware description language (HDL), and/or other forms of instruction. Additionally, for example, network elements 145 and edge device 155 may include logic to perform tasks, as described herein, based on software 320.

Communication interface 325 permits device 300 to communicate with other devices, networks, systems, devices, and/or the like. Communication interface 325 includes one or multiple radio frequency (RF) wireless interfaces and/or wired interfaces. For example, communication interface 325 may include one or multiple transmitters and receivers, or transceivers. Communication interface 325 may include one or more antennas. For example, communication interface 325 may include an array of antennas. Communication interface 325 may operate according to a protocol stack and a communication standard. Communication interface 325 may include various processing logic or circuitry (e.g., multiplexing/de-multiplexing, filtering, amplifying, converting, error correction, etc.).

Input 330 permits an input into device 300. For example, input 330 may include a keyboard, a mouse, a display, a button, a switch, an input port, speech recognition logic, a biometric mechanism, a microphone, a visual and/or audio capturing device (e.g., a camera, etc.), and/or some other type of visual, auditory, tactile, etc., input component. Output 335 permits an output from device 300. For example, output 335 may include a speaker, a display, a light, an output port, and/or some other type of visual, auditory, tactile, etc., output component. According to some embodiments, input 330 and/or output 335 may be a device that is attachable to and removable from device 300.

Device 300 may perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 cause processor 310 to perform a process described herein. Alternatively, for example, according to other implementations, device 300 performs a process described herein based on the execution of hardware (processor 310, etc.).

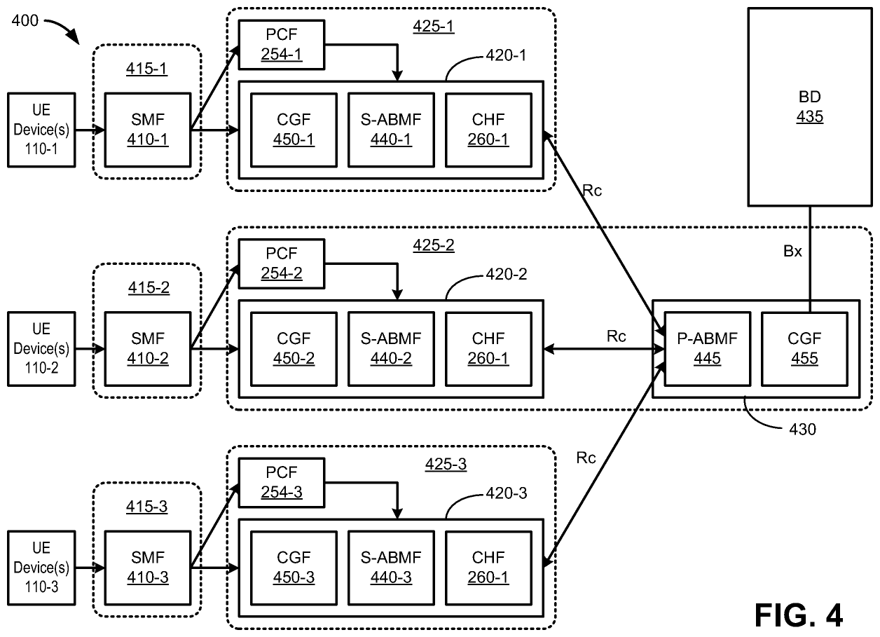

FIG. 4 is a diagram illustrating an exemplary environment 400 that may correspond to a portion of environment 100 or environment 200. More particularly, environment 400 may be used to implement hierarchical account balance management. Environment 400 may include multiple SMFs 410-1, 410-2, and 410-3 (referred to generically as “SMF 410” and collectively as “SMFs 410”) deployed at different edge data centers 415-1, 415-2, and 415-3 (referred to generically as “edge data center 415” and collectively as “edge data centers 415”); multiple CCSs 420-1, 420-2, 420-3 (referred to generically as “CCS 420” and collectively as “CCSs 420”) deployed at different core data centers 425-1, 425-2, and 425-3 (referred to generically as “core data center 425” and collectively as “core data centers 425”); an account grouper 430, and a Billing Domain (BD) 435.

Environment 400 may also include UE devices 110-1, 110-2, and 110-3 (referred to generically as “UE device 110” and collectively as “UE devices 110”). In the example of FIG. 4, UE devices 110 are in different geographic and locations associated with the same account using a shared consumption plan. Each SMF 410 may be part of a corresponding edge data center 415, which may be in different parts of edge network 150. Thus, UE device 110-1 may be located in a geographic area supported by edge data center 415-1, UE device 110-2 may be located in a geographic area supported by edge data center 415-2, and UE device 110-3 may be located in a geographic area supported by edge data center 415-3.

Each CCS 420 may be associated with a core data center 425 (e.g., that supports a particular network region or group of edge devices). Each CCS 420 may include a CHF 260, an S-ABMF 440, and a Charging Gateway Function (CGF) 450. A corresponding PCF 254 may also be associated with each core data center 425. Each CHF 260, S-ABMF 440, CGF 450, and PCF 254 may be implemented as network devices or virtual functions.

An account grouper 430 for a particular shared consumption plan account may be included in one of core data centers 425. Account grouper 430 may include a P-ABMF 445 and a Charging Gateway Function (CGF) 455.

SMF 410 may be included within an edge data center and provide corresponding functionality to SMF 240. SMF 410 may monitor a user's service usage and may generate charging events based on the usage. SMF 410 may send the charging events for a respective UE devices 110 to CCS 420 over Nchf interface 272, for example.

Each CCS 420 may be allocated and manage incremental currencies (e.g., data allotment, memory, messages, etc.) from a shared consumption plan. CHF 260 may generate charging data records (CDRs) based on usage events received from SMF 410. S-ABMF 440 may store and update a local data quota (e.g., a consumption counter limit or other currency limit) for a user's account. CGF 450 may store CDRs and perform error checking and preprocessing on the CDRs.

P-ABMF 445 may manage the global data quota for an account (e.g., a shared consumption plan). For example, based on a subscription level that a customer has purchased for a shared consumption plan, the customer may be allotted a particular amount of data (or another currency) for use during a particular billing cycle (e.g., per month, per week, per two weeks, etc.). P-ABMF 445 may keep track of the data that has been used by all the users associated with the account and the amount of data remaining during the billing cycle. As described further herein, P-ABMF 445 may communicate (e.g., via an Rc interface) with each S-ABMF 440 to allocate subsets of available data in a shared plan for use by different UE devices 110. According to an implementation, P-ABMF 445 may include a machine learning component to calculate pre-authorized consumption counter limits for different S-ABMFs 440 based on predicting usage of edge locations by UE devices 110 in a shared consumption plan.

CGF 455 may collect CDRs from CGFs 450 and perform error checking and preprocessing on the CDRs. CGF 455 may additionally transmit the collected CDRs to BD 435 over a Bx interface, for example.

BD 435 may correspond to a network element 145. BD 435 may process the CDRs received from CGF 450 to create an output. For example, BD 435 may create invoices for customers. As another example, BD 435 may process the CDRs for statistical purposes.

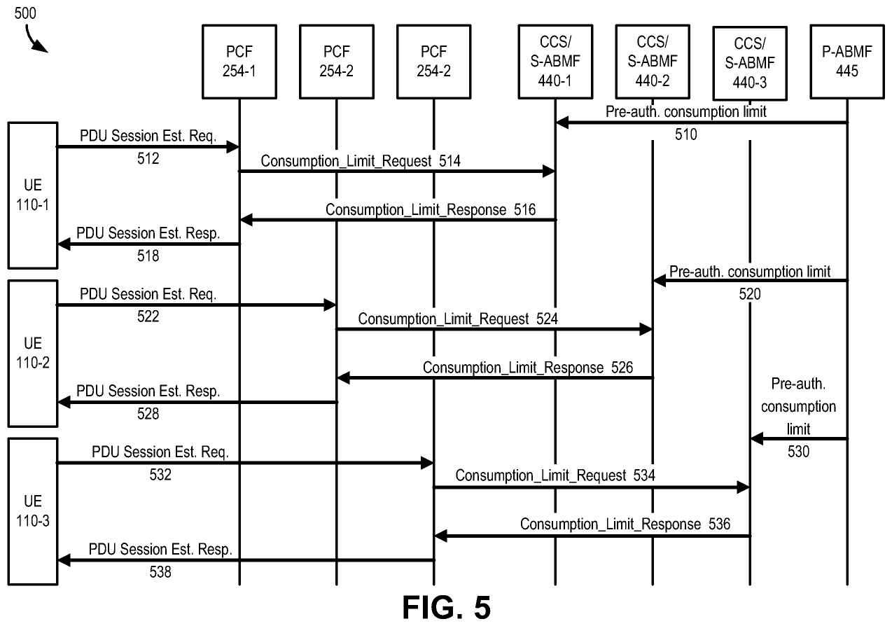

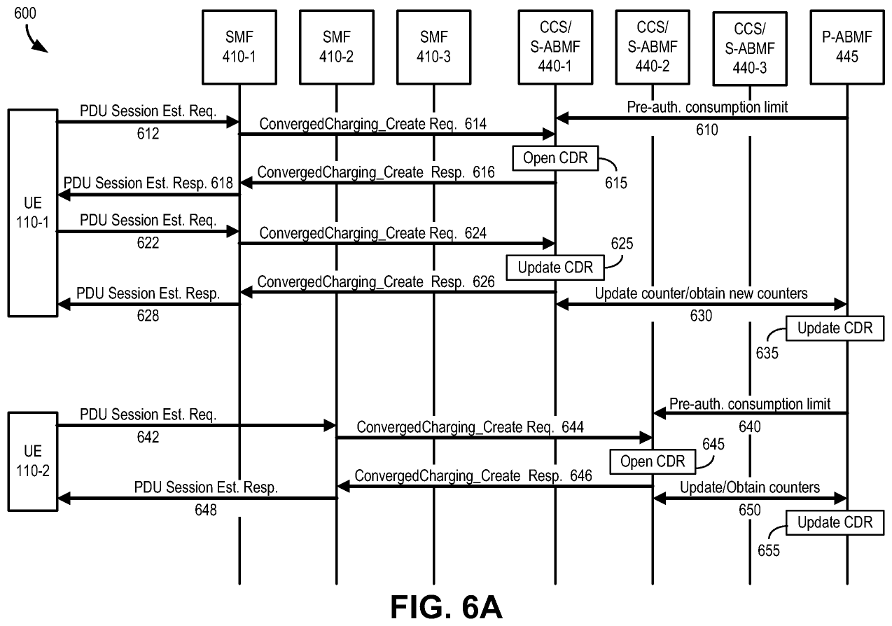

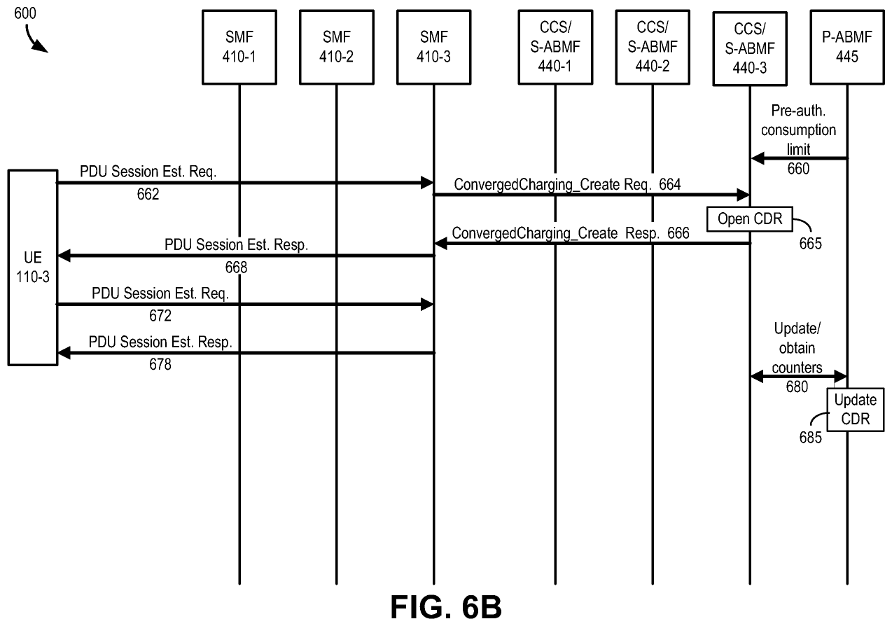

Additional functions of network elements in environment 400 are described further in connection with FIGS. 5-6B.

FIG. 5 is a diagram illustrating exemplary communications in a network portion 500 for establishing consumption limits in a hierarchical ABMF architecture. Network portion 500 may include PCFs 254-1, 254-2, and 254-3; multiple distributed account management devices (shown as S-ABMFs 440-1, 440-2, and 440-3); and a centralized account management device (shown as P-ABMF 445). Communications shown in FIG. 5 provide simplified illustrations of communications in network portion 500 and are not intended to reflect every signal or communication exchanged between devices. Furthermore, additional information not described herein may be communicated with some signals or communications.

As shown in FIG. 5, at signal 510, P-ABMF 445 may send a message to S-ABMF 440-1 including a pre-authorized consumption limit that is available for S-ABMF 440-1 to provide to UE devices 110 associated with the same account (e.g., shared consumption plan). The pre-authorized consumption limit may be a value based on a consumption counter and assigned during service activation. The pre-authorized consumption limit for each S-ABMF 440 may be a factor of or based on, for example, the number of UE devices 110 on the account, the shared currency amount, the number of relevant S-ABMFs 440, etc. For example, the shared consumption plan may include a 30 GB data limit shared among UE devices 110-1, 110-2, and 110-3. Thus, the pre-authorized consumption limit provided to S-ABMF 440-1 in signal 510 during service activation (e.g., for the shared consumption plan) may identify a subset of the 30 GB total, such as 3 GB, 5 GB, etc., for example. S-ABMF 440-1 may receive and store the pre-authorized consumption limit.

As shown by signal 512, UE device 110-1 may send a PDU session establishment request that is eventually received by PCF 254-1, where PCF 254-1 is associated with the edge network 150 or region where UE device 110-1 is connected to provider network 140. As part of the session establishment process, PCF 254-1 may send a consumption limit request 514 to S-ABMF 440-1. In response to consumption limit request 514, S-ABMF 440-1 may provide to PCF 254-1 a consumption limit response 516, which may indicate a consumption limit of some value that is no more than the value provided in pre-authorized consumption limit signal 510 (e.g., 3 GB). PCF 254-1 may receive consumption limit response 516 and forward the consumption limit to UE device 110-1 as part of a PDU session establishment response 518.

UE devices 110-2 and 110-3 may use the same shared account as UE device 110-1, while connected at different edge network 150 locations. P-ABMF 445 may send message to S-ABMF 440-2 and S-ABMF 440-3 including pre-authorized consumption limits that are available for S-ABMF 440-2 and S-ABMF 440-3 to provide to UE devices 110-2 and 110-3, respectively. Thus, signals 520-528 and signals 530-538 illustrate similar communications to signals 510-518 described above for configuring consumption limits for UE devices 110-2 and 110-3, respectively. Pre-authorized consumption limits be the same or different for each S-ABMF 440, based, for example, on a particular geographical distribution of UE devices 110 or other factors. Thus, pre-authorization of consumption counter limits to each CCS/ABMF is achieved during Service Activation of a shared consumption plan.

FIGS. 6A and 6B are diagrams illustrating exemplary communications in a network portion 600 for tracking consumption and updating counters in a hierarchical ABMF architecture. Network portion 600 may include SMF s 410-1, 410-2, and 410-3; different CCSs 420 with S-ABMFs 440-1, 440-2, and 440-3 (referred to below as CCS/S-AMBF 440); and P-ABMF 445. Communications shown in FIG. 6 provide simplified illustrations of communications in network portion 600 and are not intended to reflect every signal or communication exchanged between devices. Furthermore, additional information not described herein may be communicated with some signals or communications.

As shown in FIG. 6A, at signal 610, P-ABMF 445 may send a message to CCS/S-ABMF 440-1 including a pre-authorized consumption limit that is available for CCS/S-ABMF 440-1 to provide to UE devices 110 associated with the same account (e.g., shared consumption plan). Similar to signal 510, the pre-authorized consumption limit may be a value based on a consumption counter (e.g., that is reset on a monthly, weekly, or other period). Thus, the pre-authorized consumption limit provided to CCS/S-ABMF 440-1 in signal 610 may include a subset or portion of an account monthly data allotment, for example. CCS/S-ABMF 440-1 may receive and store the pre-authorized consumption limit. As shown by signals 640 (FIG. 6A) and 660 (FIG. 6B), P-ABMF 445 may also send to CCS/S-ABMF 440-2 and 440-3 pre-authorized consumption limits, which may be the same or different values.

As shown by signal 612, UE device 110-1 may send a PDU session establishment request that is received by SMF 410-1, where SMF 410-1 is associated with edge data center 415-1. SMF 410-1 may receive the session establishment request and, at signal 614, SMF 410-1 may send a converged charging create request associated with UE device 110-1 to CCS/S-ABMF 440-1. CCS/S-ABMF 440-1 may be included, for example, in a core data center 425-1 associated with edge data center 415-1. Converged charging create request 614 may indicate that there is a new session being setup. In response to converged charging create request 614, CCS/S-ABMF 440-1 may open 615 a charging data record (CDR) to record usage events received from SMF 410-1. CCS/S-ABMF 440-1 may store and update a local data quota (or other currency) for the shared account used by UE device 110-1. As shown in signal 616, CCS/S-ABMF 440-1 may provide a converged charging create response to SMF 410-1 to indicate the CDR is in place. SMF 410-1 may receive converged charging create response 616 and then provide a PDU session establishment response 618 to UE device 110-1.

Similarly, as shown by signal 622, UE device 110-1 may send another PDU session establishment request to SMF 410-1 for another session. SMF 410-1 may receive session establishment request 622 and, at signal 624, SMF 410-1 may send another converged charging create request associated with UE device 110-1 to CCS/S-ABMF 440-1. Converged charging create request 624 may indicate that there is another PDU session being setup. In response to converged charging create request 624, CCS/S-ABMF 440-1 may update 625 the CDR to record usage events received from SMF 410-1. As shown in signal 626, CCS/S-ABMF 440-1 may provide a converged charging create response to SMF 410-1 to indicate the CDR is updated. SMF 410-1 may receive converged charging create response 626 and then provide a PDU session establishment response 628 to UE device 110-1.

In one implementation, CCS/S-ABMF 440-1 may only need to request incremental currencies from P-ABMF 445 when approaching or exhausting the allocated usage limit provided by consumption limit 610. If the usage reported in CDR 615 and updated CDR 625 approaches or exceeds an exhaustion threshold (e.g., above 80%, 90%, etc., of the pre-authorized consumption limit), CCS/S-ABMF 440-1 may send an updated consumption counter, via signal 630, to P-ABMF 445, and P-ABMF 445 may allocate additional counters (if available in the plans shared consumption allotment). Assuming the usage reported in CDR 615 and updated CDR 625 is within the pre-authorized consumption limit, CCS/S-ABMF 440-1 may send an updated consumption counter, via signal 630, to P-ABMF 445 at the completion of PDU sessions or at a periodic interval. P-ABMF 445 may receive the updated consumption counter 630 and update 635 the global Shared Account Balance for the shared consumption plan.

As shown by signal 642, UE device 110-2 may send a PDU session establishment request that is received by SMF 410-2, where SMF 410-2 is associated with edge data center 415-1. Similar to signals 614-618 described above, as shown by signals 644-648, CCS/S-ABMF 440-2 may open 645 a CDR to record usage events received from SMF 410-2. Similar to the discussion above, in an example implementation, CCS/S-ABMF 440-2 may only need to request incremental currencies from P-ABMF 445 when approaching or exhausting the allocated limit provided by consumption limit 640. Assuming the usage reported in new CDR 645 is within the pre-authorized consumption limit, CCS/S-ABMF 440-2 may send an updated consumption counter, via signal 650, to P-ABMF 445 at the completion of the PDU session or at a periodic interval. P-ABMF 445 may receive the updated consumption counter 650, provide additional consumption limits to CCS/S-ABMF 440-2 (if needed), and update 655 the global Shared Account Balance for the shared consumption plan.

As shown by signal 662, UE device 110-3 may send a PDU session establishment request that is received by SMF 410-3, where SMF 410-3 is associated with edge data center 415-3. Similar to signals 614-618 described above, as shown by signals 664-668, CCS/S-ABMF 440-3 may open 665 a CDR to record usage events received from SMF 410-3 At a later time, as shown by signal 672, UE device 110-3 may send another PDU session establishment request to SMF 410-3. SMF 410-3 does not need to create another converged charging request because SMF 410-3 will already have the consumption counters from the previous PDU session (established at signal 668) and continue with reaching the CCS/S-ABMF 440-3. CCS/S-ABMF 440-3 may only need to request incremental currencies from P-ABMF 445 when approaching or exhausting the allocated limit provided by consumption limit 660. Assuming the usage reported in new CDR 665 is within the pre-authorized consumption limit, CCS/S-ABMF 440-3 may send an updated consumption counter, via signal 680, to P-ABMF 445 at the completion of a PDU session or at a periodic interval. P-ABMF 445 may receive the updated consumption counter 680, provide additional consumption limits to CCS/S-ABMF 440-3 (if needed), and update 685 the global Shared Account Balance for the shared consumption plan.

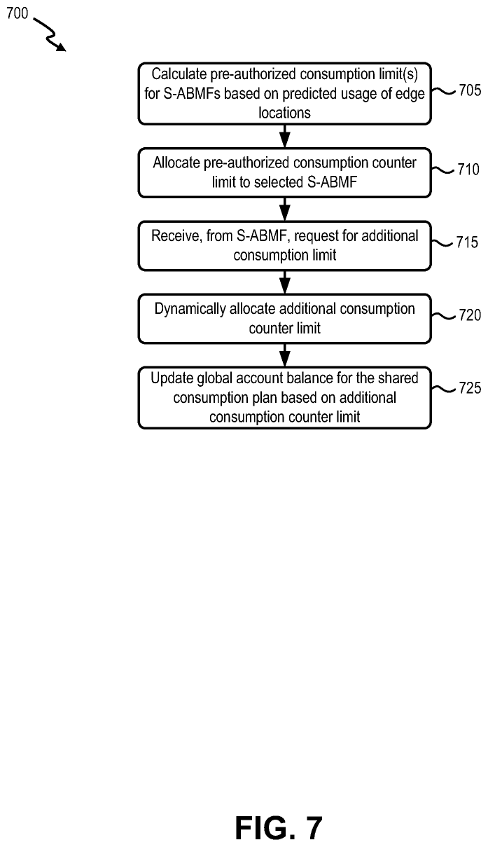

FIG. 7 is a flow diagram illustrating an exemplary process 700 for implementing a hierarchical ABMF architecture. In one implementation, process 700 may be implemented by P-ABMF 445 in connection with one or more S-ABMF 440 and one or more other devices in network portion 400.

Referring to FIG. 7, process 700 may include calculating a pre-authorized consumption counter limit based on predicted usage of edge locations by UE devices in the shared consumption plan (block 705) and allocating the pre-authorized consumption counter limit to selected S-ABMFs (block 710). For example, according to one implementation, P-ABMF 445 may provide a consumption counter limit/value to one or more S-ABMF 440. The consumption counter limit may be, for example, a portion (e.g., a percentage, etc.) of a total periodic shared plan amount. P-ABMF 445 may calculate the consumption counter limit based on a variety of factors including, for example, the number of UE devices 110 associated with an account, geographic diversity of the UE devices 110, the number of edge network locations that will provide service for the account, device/service type (e.g., IoT, gaming, massive machine-type communications (mMTC), etc.), and other factors.

Process 700 may further include receiving, from one of the multiple distributed account management devices, a request for an additional consumption limit from the shared consumption plan (block 715) and dynamically allocating, to the one of the multiple distributed account management devices, an additional consumption counter limit (block 720). For example, assuming usage reported by SMF 410 reaches the allocated consumption counter limit of S-ABMF 440, S-ABMF 440 may send a signal to P-ABMF 445 to update the consumption counter and obtain new counter limits. P-ABMF 445 may provide the update counter limits to S-ABMF 440 based on the availability and project use rates for the associated edge network/account.

Process 700 may further include updating the global account balance for the shared consumption plan based on the additional consumption counter limit (block 725). For example, P-ABMF 445 may receive updated CDRs from different S-ABMFs 440 in different regional data centers (e.g., data centers 425). P-ABMF 445 may collect, compile, and update the regional CDRs into a global account balance for the shared consumption plan. P-ABMF 445 may then be able to continuously provide new counter limits to the S-ABMFs 440 as UE devices 110 use data.

Systems and methods described herein provide a hierarchical Account Balance Management Function (ABMF) architecture for a Converged Charging System. Multiple distributed account management devices and a centralized account management device are provided. The centralized account management device includes one or more processors to allocate, to the multiple distributed account management devices, a pre-authorized consumption counter limit for a shared consumption plan; receive, from one of the multiple distributed account management devices, a request for an additional consumption counter limit from the shared consumption plan; allocate, to the one of the multiple distributed account management devices, the additional consumption counter limit; and update an account balance for the shared consumption plan based on allocating the additional consumption counter limit.

The foregoing description of implementations provides illustration and description, but is not intended to be exhaustive or to limit the invention to the precise form disclosed. Modifications and variations are possible in light of the above teachings or may be acquired from practice of the invention. For example, while a series of message flows have been described with respect to FIGS. 5-6B and a series of blocks have been described with regard to FIG. 7, the order of the message/operation flows and blocks may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

All structural and functional equivalents to the elements of the various aspects set forth in this disclosure that are known or later come to be known to those of ordinary skill in the art are expressly incorporated herein by reference and are intended to be encompassed by the claims.

What is claimed is:

1. A method comprising:
allocating, to multiple distributed account management devices and by a centralized account management device, a pre-authorized consumption limit for a shared consumption plan;
receiving, by the centralized account management device and from one of the multiple distributed account management devices, a request for an additional consumption limit from the shared consumption plan;
allocating, to the one of the multiple distributed account management devices and by the centralized account management device, the additional consumption limit; and
updating, by the centralized account management device, an account balance for the shared consumption plan based on allocating the additional consumption limit.

2. The method of claim 1, further comprising:
receiving, by the one of the multiple distributed account management devices, data usage information for a user device using the shared consumption plan; and
storing, by the one of the multiple distributed account management devices, the data usage information.

3. The method of claim 2, further comprising:
sending, by the one of the multiple distributed account management devices, the request for the additional consumption limit when use of the pre-authorized consumption limit reaches an exhaustion threshold.

4. The method of claim 2, further comprising:
sending, by the one of the multiple distributed account management devices, an account usage report on a periodic basis when use of the pre-authorized consumption limit fails to reach an exhaustion threshold.

5. The method of claim 1, wherein the shared consumption plan includes a consumption limit shared among multiple user devices.

6. The method of claim 1, wherein the multiple distributed account management devices are associated with different edge network locations.

7. The method of claim 1, wherein receiving the request for the additional consumption limit includes receiving the request via a standardized interface between the centralized account management device and the one of the distributed account management devices.

8. The method of claim 1, further comprising:
calculating, by the centralized account management device, the pre-authorized consumption limit based on predicted usage of edge locations by user devices in the shared consumption plan.

9. The method of claim 1, wherein each of the multiple distributed account management device is included within a regional Converged Charging System.

10. The method of claim 1, wherein, allocating the pre-authorized consumption limit includes predicting edge data centers to be used by user devices on the shared consumption plan.

11. A system comprising:
multiple distributed account management devices; and
a centralized account management device, the centralized account management device including one or more processors to:
allocate, to the multiple distributed account management devices, a pre-authorized consumption limit for a shared consumption plan,
receive, from one of the multiple distributed account management devices, a request for an additional consumption limit from the shared consumption plan,
allocate, to the one of the multiple distributed account management devices, the additional consumption limit, and
update an account balance for the shared consumption plan based on allocating the additional consumption limit.

12. The system of claim 11, wherein the centralized account management device is included in a core network.

13. The system of claim 11, wherein, when updating the account balance, the one or more processors is further to:
update a charging data record (CDR) for the shared consumption plan.

14. The system of claim 11, wherein each of the multiple distributed account management devices is associated with an edge network location.

15. The system of claim 11, wherein each of the multiple distributed account management devices include a processor to:
receive, from a session management device, data usage information for a user device using the shared consumption plan; and
store the data usage information.

16. The system of claim 15, wherein each of the multiple distributed account management devices further include the processor to:
send the request for the additional consumption limit when use of the pre-authorized consumption limit reaches an exhaustion threshold, and
send an account usage report on a periodic basis when use of the pre-authorized consumption limit fails to reach an exhaustion threshold.

17. The system of claim 11, wherein the one or more processors is further to:
calculate the pre-authorized consumption limit based on predicted usage of edge locations by user devices in the shared consumption plan.

18. A non-transitory computer-readable medium containing instructions executable by at least one processor, the computer-readable medium comprising one or more instructions to cause the at least one processor to:
allocate, to the multiple distributed account management devices, a pre-authorized consumption limit for a shared consumption plan of wireless network services;
receive, from one of the multiple distributed account management devices, a request for an additional consumption limit from the shared consumption plan;
allocate, to the one of the multiple distributed account management devices, the additional consumption limit; and
update an account balance for the shared consumption plan based on allocating the additional consumption limit.

19. The non-transitory computer-readable medium of claim 18, wherein the shared consumption plan includes a consumption limit shared among multiple user devices.

20. The non-transitory computer-readable medium of claim 18, wherein the multiple distributed account management devices are associated with different edge network locations.
